(19) United States
(12) Patent Application Publication
(10) Pub. No.: US 2011/0295848 A1
(43) Pub. Date: Dec. 1, 2011

(54) COMPUTER-IMPLEMENTED SYSTEM AND METHOD FOR DETERMINING A RESPONSE TO A STIMULUS

(76) Inventors: Michael D. Peters, Lords Valley, PA (US); Daniel I. Harnden, New York, NY (US)

(21) Appl. No.: 13/149,342

(22) Filed: May 31, 2011

Related U.S. Application Data
(60) Provisional application No. 61/349,497, filed on May 28, 2010.

(51) Int. Cl. G06F 17/30

(52) U.S. Cl. 707/723; 707/769; 707/E17.014

(57) ABSTRACT

The present invention provides a computer based, online and mobile app system that collects, filters and aggregates market data by flashing products, music clips, words, photos and other images at users and measuring the speed of their responses to 1/100^{th} of a second. User decisions and response times are sent to a database where they are compared to aggregate responses. The system compares the results to aggregate responses and speeds in its database to create ratings for every product, music clip, word, photo, other image, and user. An accounting of the user's relative position as a rater, as well as an accounting of their responses to the product, music clip, word, photo, other image they have rated, are sent back to the user's mobile device or computer. In this process, a searchable database of public opinion is created and hosted online, or in the cloud, that will automatically and continually be updated in real time.

### CROSS-REFERENCE TO RELATED APPLICATIONS

This application is related to and claims priority from U.S. Provisional Patent Application Ser. No. 61/349,497 filed on May 28, 2010.

### FIELD OF THE INVENTION

The present invention relates, in general, to marketing research and, more particularly, this invention relates to an online and mobile app system that collects, filters and aggregates market data.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, market data collection and analysis is an important part of product development and marketing. Many methods have been used and are currently still in use to determine the marketability of a particular product. Some of the more common methods include polling individuals, focus groups, beta/prototype testing and more recently data mining. While data mining has produced promising marketing results, the methods used are sometimes ethically questionable or simply poor for public relations. Also, all of the above methods can be labor intensive and expensive to conduct.

Therefore, there is a need for an improved method and system that overcomes the disadvantages of prior and current methods.

### SUMMARY OF THE INVENTION

The present invention provides a computer based, online and mobile app system that collects, filters and aggregates market data by flashing products, music clips, words, photos and other images at users and measuring the speed of their responses to 1/100^{th} of a second. User decisions and response times are sent to a database where they are compared to aggregate responses. The system compares the results to aggregate responses and speeds in its database to create ratings for every product, music clip, word, photo, other image, and user. An accounting of the user's relative position as a rater as well as an accounting of the user's responses to the products, music clips, words, photos and other images the user has rated are sent back to the user's mobile device or computer. In this process, a searchable database of public opinion is created and hosted online, or in the cloud, that will automatically and continually be updated in real time. As a game, the object is to guess what the most and least popular products, music clips, words, photos and other images are in as little time a possible.

In several preferred embodiments the system is a high-speed search engine with the added function of rating the user and what the user is searching. For music, art and dating applications, the user could upload images and sound clips into the system via their phone or home computer. In terms of getting images from the Internet, the present invention could use “web scraping” with a server-side language such as perl, PHP or the like. The process would involve performing a global regular expression match on the images a user is looking for. Using current mobile network technology, the mobile app could communicate with a server that is connected to a mySQL database or the like.

In several embodiments the invention connects shopping, marketing, research and gaming into one user-friendly system. The speed and accuracy of user decisions are measured against that of the aggregate to produce ratings for users and products. In several embodiments the invention offers several modes of engagement for the online and mobile user; including gaming, auditioning, and referencing. In a preferred embodiment of the image gaming mode, each product, word, photo or other image is onscreen for a limited amount of time. Two seconds is the current preferred default, but other time period could be used depending on the application. The user may have either two or three buttons to choose from. In cases in which the user has two buttons to choose from the options will be: LIKE, DON'T LIKE. In cases in which the user has three buttons to choose from, the options will be LIKE, DON'T KNOW, DON'T LIKE. In cases in which the user has three buttons to choose from, an automatic vote of DON'T KNOW is registered if a selection is not made before the determined time runs out and another image appears onscreen. In a preferred embodiment the DON'T KNOW button is not provided to the user. Instead it uses a default time to replace the DON'T KNOW button/function. The speed and “accuracy” of all decisions are recorded to create ratings and charts for images (products) and users. (Accuracy equals the individual's ability to guess what the most and least popular images are and how close an individual's assessment of an image is to the assessment of the aggregate. The object of the ‘game’ is to get users to make the most honest choice they can).

Speed-Shopping is another outcome of the present invention. It is an innovative approach to increasing sales and conducting market research. It enables users to speed through large inventories and connect with their inner decision-making process. For retailers and manufacturers, it represents a new way to discover what customers want or don't want and precisely how much they want or don't want it. Using shoes as an example, the data collected can tell retailers what shoes will be popular or unpopular regionally, and in what demographic, before the shoes are purchased, manufactured or shipped to outlets.

Browsing is another way to use the system. Although it is not as lightning fast as Speed-Shopping, it is still a quick and effective way to search, organize and rate large inventories, generating valuable market data streamlining the decision making process.

Referencing is an example of the system's most passive mode. By rating the user who is rating the product, a network of vetted reviews and reviewers is created. In this instance, the system could be thought of as an encyclopedia of market (consumer) information.

In a preferred embodiment of the Music gaming mode each music clip starts at the songs “hook”, or whatever spot the artist, publisher, record company choose as the most immediately compelling, and is onscreen for as long as the user chooses. The user may have either two or three buttons to choose from. In cases in which the user has two buttons to choose from the options will be: HIT, MISS. In cases in which the user has three buttons to choose from, the options will be HIT, MISS, SKIP. As soon as the user makes a choice, the next music clip begins at its ‘hook’. The speed and “accuracy” of all decisions are recorded to create ratings and charts for music clips and users. (Accuracy equals the individual's ability to guess what the most and least popular songs are and how close an individual's assessment of a song is to the assessment of the aggregate). The user has the same two or three buttons to choose from. In the case of two buttons: LIKE, DON'T LIKE (HIT, MISS—music game only). In the case of three buttons: LIKE, DON'T KNOW, DON'T LIKE (HIT, MISS, SKIP—music game only).

In a preferred embodiment of the audition mode, each product, music clip, word, photo or other image is onscreen for an unlimited amount of time. (Some images would be displayed for multi image viewing—three views). The user has the same three buttons to choose from: LIKE, DON'T KNOW, DON'T LIKE (HIT, MISS, SKIP—music game only). Time spent on an image or music clip, and user decisions, are recorded to create ratings and charts for products and users. Typically, the quicker the response time the more strongly the response is scored. For example, a “LIKE” selection with a short response time will have a greater value (and thus a greater affect on the aggregate score) than a “LIKE” response with a longer response time.

In a preferred embodiment of the audition reference mode, users can access reviews from vetted reviewers for each product, music clip, word, photo or other image without having to play or audition.

In other preferred embodiments aimed at use for retail, the invention could be a mobile app that generates social networks as it collects data or a system for the presentation and sale of products. The invention could be used to identify product trends and offer vendors vital market information before they invest in manufacturing, warehousing or shipping products. The present invention could be used to induce and track instinctual reactions, filling shopping carts and building wish lists; connecting retail, shopping, marketing, researching, purchasing, and gaming into one user-friendly system. The invention's modes of engagement may include: speed shopping, auditioning, and comparison-shopping. The invention is fast, easy, fun, and engaging, it can take customers from engagement to point-of-purchase in less than sixty seconds. The invention provides a means for quickly and efficiently moving through large inventories, getting more customer eyes on more products. The present invention also provides a system of polling based on reactions to single images or words as opposed to a series of questions. In many embodiments the invention compares individual results to aggregate responses to create ratings for every product, image and user. It is preferred that every user has an identity and rating on the charts along side of products and artists. The present invention can generates social networks of optimized mobile websites exclusively or partly empowered by users. The present invention can also generate instantaneous public opinion polling available in real-time charts. The present invention can target communities for data collection and advertising. In several embodiments the present invention feels like a game or search without the intrusion or drudgery of polling. Also, it does not require the user to disclose their personal data.

In other preferred embodiments aimed at use for music and art, the invention could be a mobile app that generates social networks as it collects data. In other embodiments the invention is a fast, fun and rewarding auditioning system for music and art. The present invention can connect music and gaming. It is envisioned an extreme music auditioning application skewed toward young males would be with in the scope of the invention. In several preferred embodiments the invention could charge artists a modest upload fee for music or other art. The present invention compares individual results to aggregate responses to create ratings for every song, work of art, artist and user. In several other embodiments of the invention modes of engagement include: extreme auditioning and browsing. In several embodiments the invention uses or creates a free market of music, it reflects the minute to minute ups and downs of the marketplace. In several embodiments all contributing artists become listed artists with ratings. In several embodiments all users become listed users with ratings. The present invention can quickly and efficiently moves through large inventories, crucial for on line music retailers and the like. The present invention is able to target communities and demos for data collection and advertising.

### OBJECTS OF THE INVENTION

It is, therefore, one of the primary objects of the present invention to provide a method and system for collecting and analyzing market data.

Another object of the present invention is to provide a method and system for collecting and analyzing market data that can adjust ratings in real time.

Yet another object of the present invention is to provide a method and system for collecting and analyzing market data that is more advantageous over polling.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 shows a schematic view of a preferred embodiment of the system's hardware and connections.

FIG. 2 shows a version of the game interface for a shoe game.

FIG. 3 shows a version of the game results page for a shoe game.

FIG. 4 shows a version of the game interface for a music game.

FIG. 5 shows a version of the game results page for a music game.

FIG. 6 shows a chart demonstrating a preferred algorithm for ranking the various scores of the current invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of response indicating means and response selection means applies to real buttons, virtual buttons, touch screen display, keyboard, computer mouse, or any user input device or means.

It is to be understood that the definition of means for receiving, transmitting, storing said stimulus applies to receivers, transmitters, telecommunication devices and data storage devices and the like.

It is to be understood that the definition of processing means applies to microprocessors, computer processors and other processing devices.

It is to be understood that the definition of comparing means applies to microprocessors configured to compare data, computers configured to compare data, electronic comparators and other devices capable of comparing data.

It is to be understood that the definition of display and audio means applies to monitors, electronic displays, mechanical displays, audio speakers and media devices capable of visual or audio output.

It is to be understood that the definition of means for transmitting selected response applies to data telecommunication devices, buttons, and the like.

It is to be understood that the definition of means for measuring time applies to clocks, timers, clock circuits, time keeping devices, and the like.

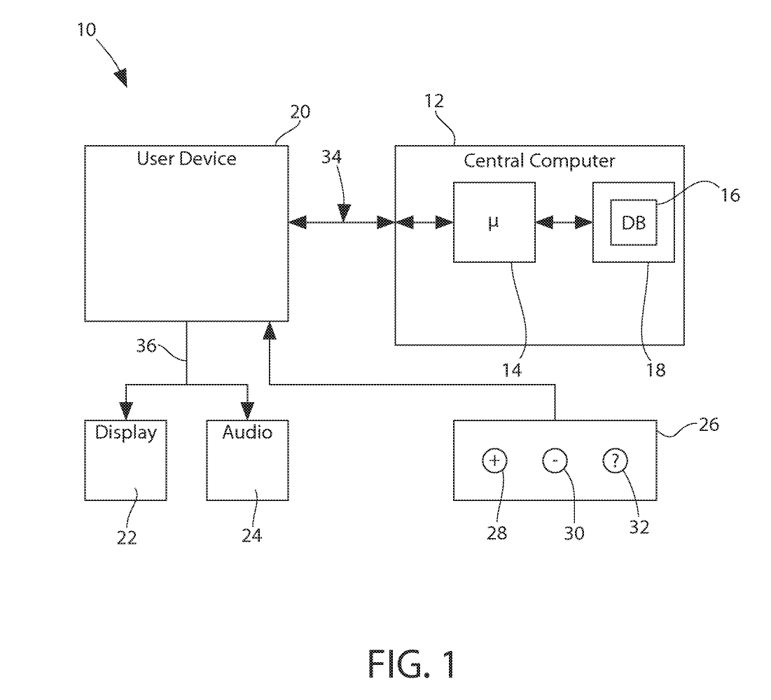

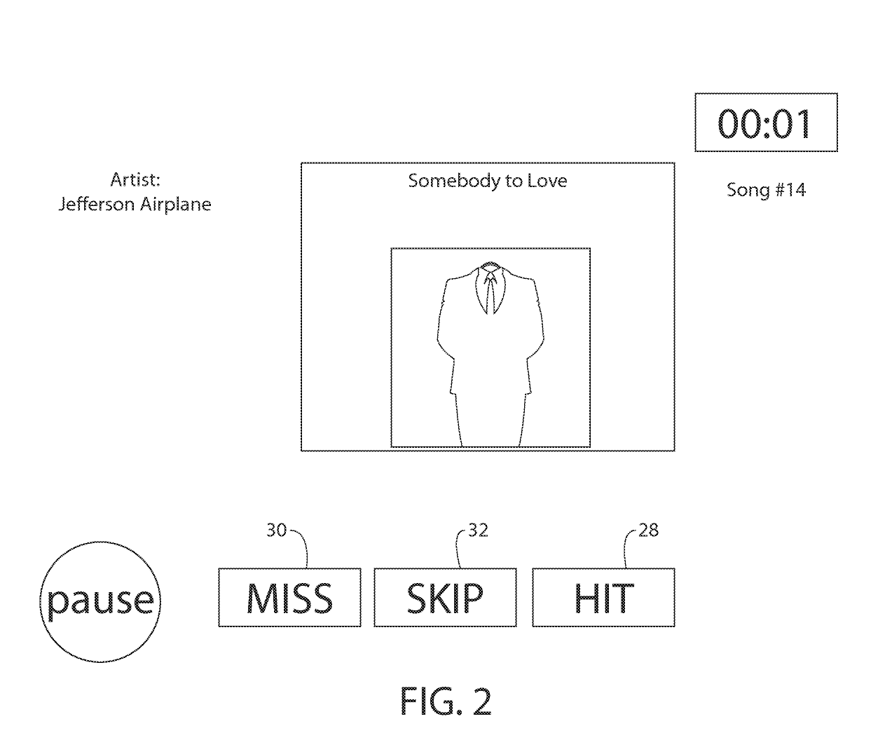

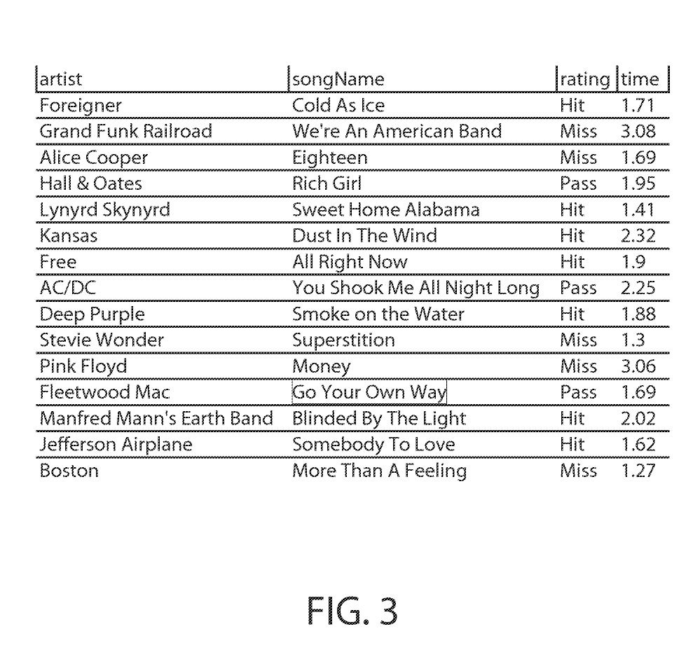

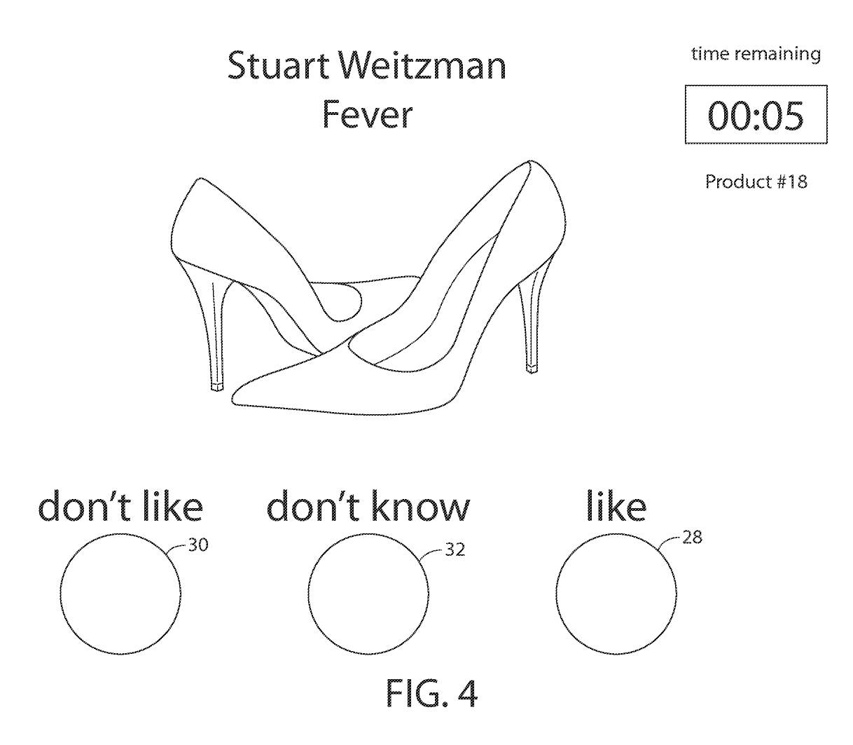

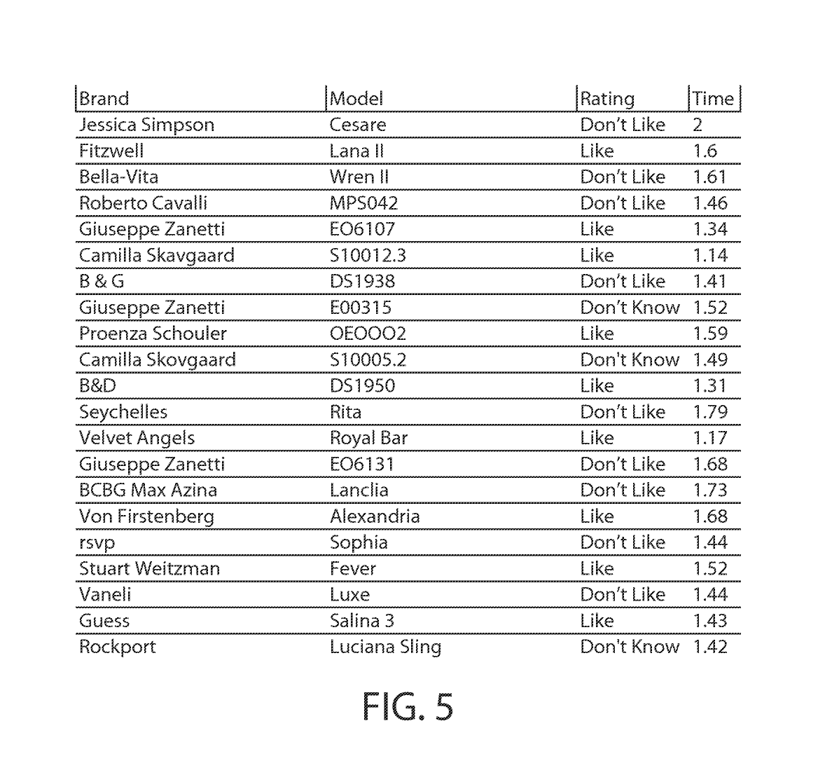

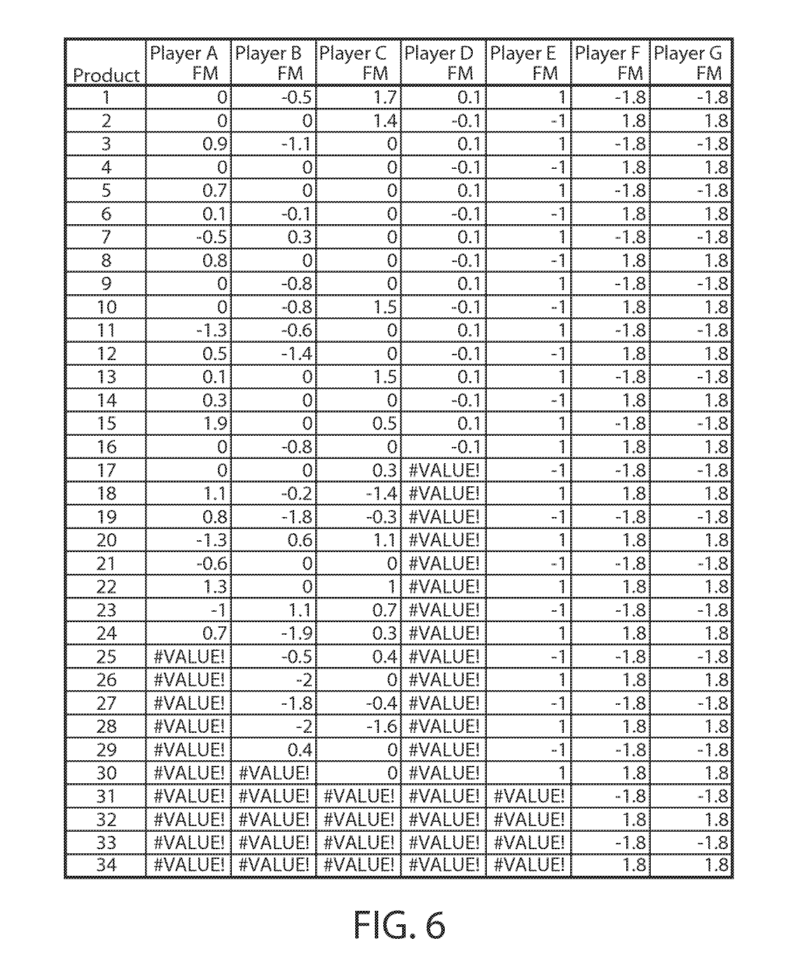

The best mode for carrying out the invention is presented in terms of its presently preferred embodiment, herein depicted within FIGS. 1 through 6. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The present invention describes a system and method for collecting, filtering and aggregating market data. (herein described as the “present invention”), generally designated as 10, which provides means to collect, filter and aggregate market data.

Reference is now made, to FIG. 1, wherein there is shown a system generally designated as 10, for collecting, filtering and aggregating market data. The system comprises a central computer 12 with processing means 14 and database 16 on data storage means 18. The system further comprises user electronic device 20 with display 22 and audio output 24, and response selection means 26 with positive response input 28, negative response input 30 and neutral response input 32. User electronic device 20 preferably uses a two way communication means 34 to communicate data to and from central computer 12. Two way communication means 34 can be any suitable communication means known in the art but preferably this communication comprises the Internet, but could comprise wireless communication means, hard wire communication means or any other suitable means. Stimulus communication means 36 transmits data for use as a stimulus. This means can all also be any suitable means known in the art. Response selection communication means 38 communicates selected response data to the user device. It is envisioned that touch screen technology and other current and future user display and input devices could be used and could be connected on a common cable or other means.

Reference is now made to FIGS. 1 through 6, which demonstrate several embodiments of the present invention. In game mode products, music clips, words, photos and other images are flashed at the user one at a time for a total of thirty seconds (default). The user can choose two or three buttons to choose from. In the case of two buttons: LIKE, DON'T LIKE (HIT, MISS—music game only). In the case of three buttons: LIKE, DON'T KNOW, DON'T LIKE (HIT, MISS, SKIP—music game only). In the Image game, which, in the case of two buttons, uses a default time to replace a DON'T KNOW or SKIP button, if the user fails to choose a button before two seconds elapse (default), a new image automatically appears and a DON″T KNOW vote is registered. In the music game, when the user makes a choice, the next music clip begins at its ‘hook’, or whatever spot the artist, publisher, record company choose as the most immediately compelling. If the user does not make a choice, the music clip continues to play until game time has run out.

The user can choose one of the two or three buttons. In the case of two buttons: LIKE, DON'T LIKE (HIT, MISS—music game only). In the case of three buttons: LIKE, DON'T KNOW, DON'T LIKE (HIT, MISS, SKIP—music game only). A new image automatically appears once a vote is registered.

The present invention can be directed to use a variety of existing third party databases. The present invention preferably includes counters to keep track of LIKE, DON'T KNOW, DON'T LIKE choices; counters to keep track of HIT, MISS, SKIP choices; counters to keep track of total number of choices made; registration (prior to first engagement only); results page with game play info; favorites list; product ratings (user & aggregate); user ratings (individual & aggregate); name of product, photo, or other image; title of music clip and name of artist (music game only); and other features or option may be beneficial depending on application.

Reference is now made, to FIG. 1, wherein there is shown a chart demonstrating a preferred algorithm for ranking the various scores of the current invention. Player FM is the score recorded for each player for each product. Player FM is the answer value multiplied by speed points. The specific values can vary, but high positive Player FM scores indicates a rapid positive response and high negative Player FM scores indicates a rapid negative response. Whereas, low positive Player FM scores indicates a slow positive response and low negative Player FM scores indicates a slow negative response. A Player FM value of 0 indicates no answer or response was given. A player FM value of “#VALUE!” indicates the product or image was not viewed.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A computer-implemented method for determining a response to a stimulus comprising:
(a) presenting, from a central computer, said stimulus to an individual;
(b) providing said individual with a response indicating means;
(c) selecting, by said individual with said response indicating means, said response to said stimulus;
(d) measuring a individual's response time between presenting said stimulus and selecting said response;
(e) storing each of said measured time and said selected response to a database; and
(f) comparing at least one of said response time and said response against predetermined data.

2. The method, according to claim 1, wherein said response indicating means comprises a positive indicator input and a negative indicator input.

3. The method of claim 1, wherein said response indicating means comprises at least one of a positive response input, a negative response input, and a neutral response input.

4. The method of claim 1, further comprising the step of setting a maximum time for said individual to select said response.

5. The method of claim 4, further comprising the step of selecting, by said central computer, a predetermined response if said individual exceeded said maximum time for said individual to select said response.

6. The method of claim 1, further comprising the step of calculating a score based on, at least in part, said response time and said response.

7. The method of claim 1, further comprising the step of calculating a score based on, at least in part, said response time, said response and said stimulus.

8. The method of claim 1, further comprising the step of calculating a score based on, at least in part, said response time, said response, said stimulus and a predetermined data set from a central database.

9. A computer-implemented system for determining a response of an individual to a stimulus comprising:
(a) a central computer including:
i. a centralized database,
ii. means for at least one of receiving, transmitting and storing said stimulus in an electronic data format,
iii. a processing means,
iv. a data comparing means;
(b) a local device including:
i. means for receiving said stimulus from said central computer,
ii. at least one of a display and audio means configured to communicate said received stimulus to an individual,
iii. a response selection means disposed integral with or external to said local device, and
iv. means for transmitting selected response; and
(c) means for measuring time between communicating said received stimulus to the individual and selecting a response to said communicated stimulus.

10. The system of claim 9, wherein said central computer selects a predetermined response if said individual exceeded a maximum time for selecting said response to said communicated stimulus.

11. The system of claim 9, wherein said central computer calculates a score based on, at least in part,
(a) time between communicating said received stimulus to the individual and selecting a response to said communicated stimulus, and
(b) said response to said communicated stimulus.

12. The system of claim 9, wherein said central computer calculates a score based on, at least in part,
(a) time between communicating said received stimulus to the individual and selecting a response to said communicated stimulus,
(b) said response to said communicated stimulus, and
(c) said received stimulus.

13. The system of claim 9, wherein said central computer calculates a score based on, at least in part,
(a) time between communicating said received stimulus to the individual and selecting a response to said communicated stimulus,
(b) said response to said communicated stimulus,
(c) said received stimulus, and
(d) a predetermined data set from said centralized database.
